(19) United States
(12) Patent Application Publication
(10) Pub. No.: US 2018/0035376 A1
(43) Pub. Date: Feb. 1, 2018

(54) NAN Frame Buffering Indications

(71) Applicant: Apple Inc., Cupertino, CA (US)

(72) Inventors: Yong Liu, Campbell, CA (US); Christiaan A. Hartman, San Jose, CA (US); Lawrie Kurian, San Jose, CA (US); Peter N. Heerboth, San Jose, CA (US)

(21) Appl. No.: 15/645,344

(22) Filed: Jul. 10, 2017

Related U.S. Application Data
(60) Provisional application No. 62/368,240, filed on Jul. 29, 2016.

(51) Int. Cl. H04W 52/02; H04L 12/861; H04W 68/00; H04W 72/12; H04W 8/00; H04W 56/00

(52) U.S. Cl. CPC H04W 52/0235; H04W 8/005; H04W 56/001; H04W 68/00; H04W 72/12; H04L 49/90; H04W 84/12

(57) ABSTRACT

In embodiments, one or more wireless stations operate to configure direct communication with neighboring mobile stations, i.e., direct communication between the wireless stations without utilizing an intermediate access point. Embodiments of the disclosure relate to NAN datapath scheduling and NAN pre-datapath operation setup and scheduling. The NAN datapath embodiments described herein provide a mechanism through which stations can communicate and provide services. In particular, embodiments described herein relate to the use of data buffering indications in a NAN communication system.

### PRIORITY INFORMATION

This application claims priority to U.S. provisional patent application Ser. No. 62/368,240, entitled “NAN Frame Buffering Indications,” filed Jul. 29, 2016, which is hereby incorporated by reference in its entirety as though fully and completely set forth herein.

### FIELD

The present application relates to wireless communications, including techniques for wireless communication among wireless stations in a wireless networking system.

### DESCRIPTION OF THE RELATED ART

Wireless communication systems are rapidly growing in usage. Further, wireless communication technology has evolved from voice-only communications to also include the transmission of data, such as Internet and multimedia content. A popular short/intermediate range wireless communication standard is wireless local area network (WLAN). Most modern WLANs are based on the IEEE 802.11 standard (or 802.11, for short) and are marketed under the Wi-Fi brand name. WLAN networks link one or more devices to a wireless access point, which in turn provides connectivity to the wider area Internet.

In 802.11 systems, devices that wirelessly connect to each other are referred to as “stations”, “mobile stations”, “user devices” or STA or UE for short. Wireless stations can be either wireless access points or wireless clients (or mobile stations). Access points (APs), which are also referred to as wireless routers, act as base stations for the wireless network. APs transmit and receive radio frequency signals for communication with wireless client devices. APs can also typically couple to the Internet in a wired fashion. Wireless clients operating on an 802.11 network can be any of various devices such as laptops, tablet devices, smart phones, or fixed devices such as desktop computers. Wireless client devices are referred to herein as user equipment (or UE for short). Some wireless client devices are also collectively referred to herein as mobile devices or mobile stations (although, as noted above, wireless client devices overall may be stationary devices as well).

In some prior art systems Wi-Fi mobile stations are able to communicate directly with each other without using an intermediate access point. However, improvements in the operation of such devices are desired, such as in setup and coordination of the communication between such devices.

### SUMMARY

Embodiments described herein relate to systems, apparatuses, and methods for using neighbor awareness network (NAN) frame buffering indications.

Embodiments relate to a wireless station that includes one or more antennas, one or more radios, and one or more processors coupled (directly or indirectly) to the radios. At least one radio is configured to perform Wi-Fi communications. The wireless station may perform voice and/or data communications, as well as the methods described herein.

In some embodiments, one or more wireless stations operate to configure direct communication with neighboring mobile stations, i.e., direct communication between the wireless stations without utilizing an intermediate access point. Embodiments of the disclosure relate to the use of frame buffering indications. For example, a wireless station may provide an indication requesting that another station buffer data for the wireless station, and/or indicating that the wireless station will buffer data for the other wireless station, and/or indicating that the wireless station has no further data buffered for the other wireless station (e.g., which may allow the other wireless station to respond with an indication to buffer data for the other wireless station if it also has no further data buffered for the wireless station). Use of such indications may facilitate power conservation among wireless stations performing direct communication, as it may allow such stations agreeing to buffer data for each other to enter a low power (e.g., sleep) mode until a (e.g., predetermined/agreed-upon) later time. Note that the frame buffering indications may be implemented for unicast and/or multicast communication between wireless stations.

Note that the techniques described herein may be implemented in and/or used with a number of different types of devices, including but not limited to base stations, access points, cellular phones, portable media players, tablet computers, wearable devices, and various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example WLAN communication system, according to some embodiments;

FIG. 2 illustrates an example simplified block diagram of a WLAN Access Point (AP), according to some embodiments; and

FIG. 3 illustrates an example simplified block diagram of a mobile station (UE), according to some embodiments;

FIG. 4 is a flowchart diagram illustrating an example method for using frame buffering indications in a NAN communication system, according to some embodiments;

FIG. 5 illustrates an example of a possible NAN communication schedule among several wireless stations, according to some embodiments;

FIG. 6 illustrates an example of a possible NAN communication timeline between two wireless stations that have established a P-NDL, according to some embodiments;

FIG. 7 illustrates an example of a possible NAN communication timeline between two wireless stations that have established a S-NDL, according to some embodiments;

FIG. 8 illustrates an example of a possible 802.11 infrastructure mode communication timeline between an AP and a STA that includes use of data buffering indications, according to some embodiments;

FIGS. 9-11 illustrate examples of possible NAN communication timelines in which frame buffering indications may be used, according to some embodiments;

FIGS. 12-13 illustrate example approaches to arranging rendezvous points when using frame buffering indications, according to some embodiments;

FIGS. 14-16 illustrate examples of possible NAN communication timelines in which no buffered frames indications may be used; and

FIG. 17 illustrates an example of a possible NAN communication timeline between two STAs in which one of the STAs implements an awake period.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of the most prominently used acronyms that may appear throughout the present application are provided below:

UE: User Equipment

AP: Access Point

DL: Downlink (from BS to UE)

UL: Uplink (from UE to BS)

TX: Transmission/Transmit

RX: Reception/Receive

LAN: Local Area Network

WLAN: Wireless LAN

RAT: Radio Access Technology

DW: Discovery Window

NW: Negotiation Window

FAW: Further Availability Window

NAN: neighbor awareness network

NDL: NAN Data Link

NDC: NAN Data Cluster

CRB: Common Resource Block

TIM: Traffic Indication Map

RP: Rendezvous Point

### Terminology

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Mobile Device (or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™, etc. Various other types of devices would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (or combination of devices) which is easily transported by a user and capable of wireless communication using WLAN or Wi-Fi.

Wireless Device (or Wireless Station)—any of various types of computer systems devices which performs wireless communications using WLAN communications. As used herein, the term “wireless device” may refer to a mobile device, as defined above, or to a stationary device, such as a stationary wireless client or a wireless base station. For example a wireless device may be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element—refers to various implementations of digital circuitry that perform a function in a computer system. Additionally, processing element may refer to various implementations of analog or mixed-signal (combination of analog and digital) circuitry that perform a function (or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

NAN data link (NDL)—refers to a communication link between peer wireless stations (e.g., peer NAN devices). Note that the peer devices may be in a common (e.g., same) NAN cluster. In addition, a NAN data link may support one or more NAN datapaths between peer wireless stations. Note further that a NAN data link may only belong to a single NAN data cluster.

NAN datapath (NDP)—refers to a communication link between peer wireless stations that supports a service. Note that one or more NAN datapaths may be supported by a NAN data link. Additionally, note that a NAN datapath supports a service between wireless stations. Typically, one of the peer wireless stations will be a publisher of the service and the other peer wireless station will be a subscriber to the service.

NAN cluster—refers to multiple peer wireless stations linked via synchronization to a common time source (e.g., a common NAN clock). Note that a peer wireless station may be a member of more than one NAN cluster.

NAN data cluster (NDC)—refers to a set of peer wireless stations in a common (e.g., same) NAN cluster that share a common base schedule (e.g., a NAN data cluster base schedule). In addition, peer wireless stations in a NAN data cluster may share at least one NAN data link that includes an active datapath with another member wireless station within the NAN data cluster.

Note that a peer wireless station may be a member of more than one NAN cluster; however, as noted previously, a NAN data link belongs to exactly one NAN data cluster. Note further, that in a NAN data cluster, all member peer wireless stations may maintain tight synchronization (e.g., via a NAN data cluster base schedule) amongst each other and may be present at a common (e.g., same) further availability slot(s) (or window(s)) as indicated by a NAN data cluster base schedule. In addition, each NAN data link may have its own NAN data link schedule and the NAN data link schedule may be a superset of a NAN data cluster base schedule.

Automatically—refers to an action or operation performed by a computer system (e.g., software executed by the computer system) or device (e.g., circuitry,

programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, e.g., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, signaling, messaging, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

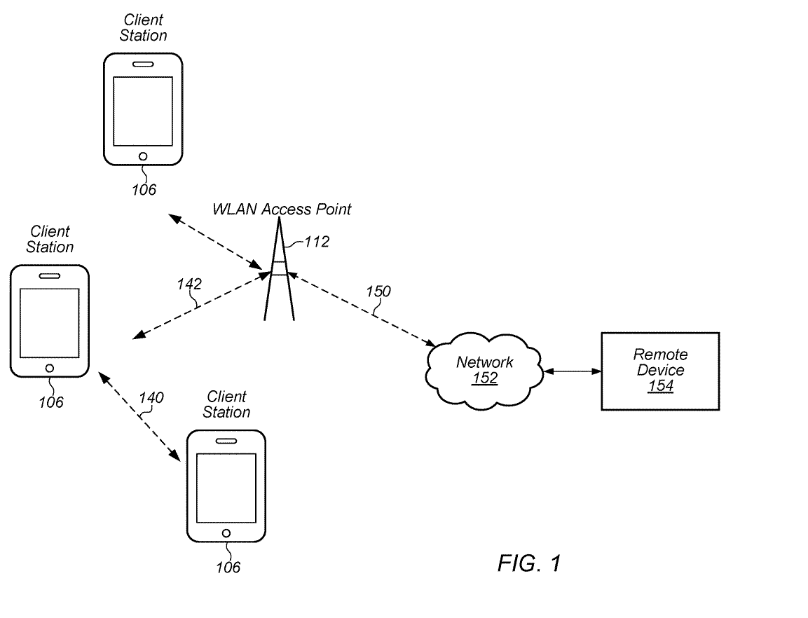

### FIG. 1—WLAN System

FIG. 1 illustrates an example WLAN system according to some embodiments. As shown, the example WLAN system includes a plurality of wireless client stations or devices, or user equipment (UEs), 106 that are configured to communicate over a wireless communication channel 142 with an Access Point (AP) 112. The AP 112 may be a Wi-Fi access point. The AP 112 may communicate via a wired and/or a wireless communication channel 150 with one or more other electronic devices (not shown) and/or another network 152, such as the Internet. Additional electronic devices, such as the remote device 154, may communicate with components of the WLAN system via the network 152. For example, the remote device 154 may be another wireless client station. The WLAN system may be configured to operate according to any of various communications standards, such as the various IEEE 802.11 standards. In some embodiments, at least one wireless device 106 is configured to communicate directly (e.g., via wireless communication channel 140) with one or more neighboring mobile devices, without use of the access point 112.

In some embodiments, as further described below, a wireless device 106 may be configured to perform methods for utilizing frame buffering indications in conjunction with NAN communication.

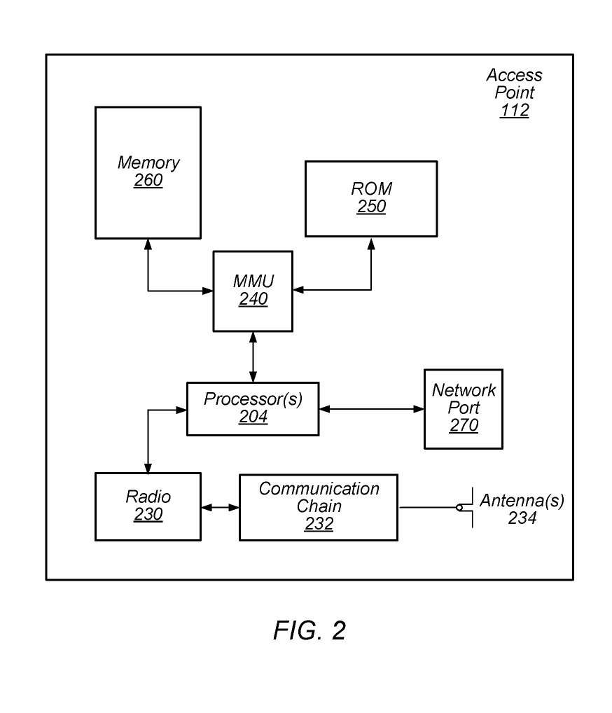

### FIG. 2—Access Point Block Diagram

FIG. 2 illustrates an example block diagram of an access point (AP) 112. It is noted that the block diagram of the AP of FIG. 2 is only one example of a possible system. As shown, the AP 112 may include processor(s) 204 which may execute program instructions for the AP 112. The processor(s) 204 may also be coupled (directly or indirectly) to memory management unit (MMU) 240, which may be configured to receive addresses from the processor(s) 204 and to translate those addresses to locations in memory (e.g., memory 260 and read only memory (ROM) 250) or to other circuits or devices.

The AP 112 may include at least one network port 270. The network port 270 may be configured to couple to a wired network and provide a plurality of devices, such as wireless devices 106, access to the Internet. For example, the network port 270 (or an additional network port) may be configured to couple to a local network, such as a home network or an enterprise network. For example, port 270 may be an Ethernet port. The local network may provide connectivity to additional networks, such as the Internet.

The AP 112 may include at least one antenna 234, which may be configured to operate as a wireless transceiver and may be further configured to communicate with wireless device 106 via wireless communication circuitry 230. The antenna(s) 234 communicates with the wireless communication circuitry 230 via communication chain 232. Communication chain 232 may include one or more receive chains, one or more transmit chains or both. The wireless communication circuitry 230 may be configured to communicate via Wi-Fi or WLAN, e.g., 802.11. The wireless communication circuitry 230 may also, or alternatively, be configured to communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it may be desirable for the AP 112 to communicate via various different wireless communication technologies.

The AP 112 may be configured to act as an access point to provide an infrastructure mode 802.11 network to wireless stations in the vicinity of the AP 112. Additionally or alternatively, the AP 112 may be configured to act as a peer station to perform peer-to-peer communications with nearby wireless stations. In some embodiments, as further described below, AP 112 may be configured to perform methods for utilizing frame buffering indications in conjunction with NAN communication, for example when communicating with one or more other wireless stations as a peer.

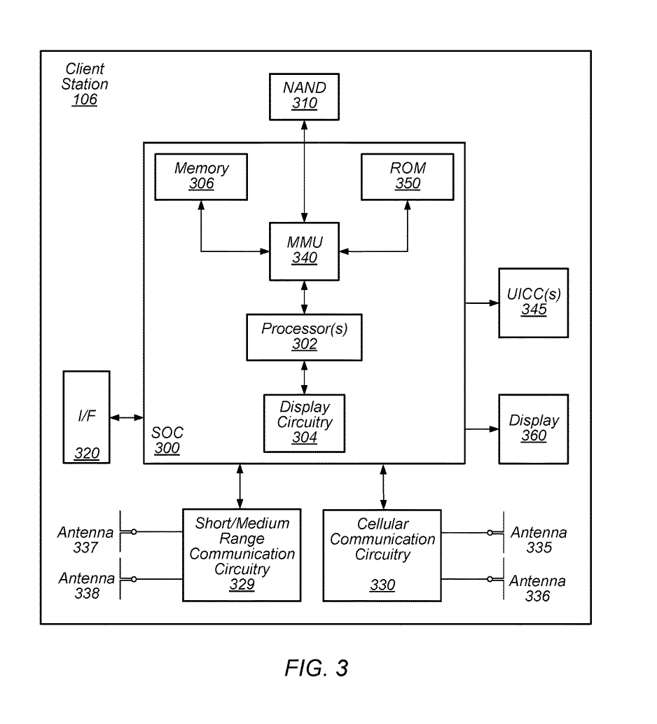

### FIG. 3—Client Station Block Diagram

FIG. 3 illustrates an example simplified block diagram of a client station 106. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (or dock) 320 (e.g., for coupling to a computer system, dock, charging station, etc.), the display 360, cellular communication circuitry 330 such as for LTE, GSM, etc., and short to medium range wireless communication circuitry 329 (e.g., Bluetooth™ and WLAN circuitry). The client station 106 may further include one or more smart cards that incorporate SIM (Subscriber Identity Module) functionality, such as one or more UICC(s) (Universal Integrated Circuit Card(s)) 345. The cellular communication circuitry 330 may couple to one or more antennas, such as antennas 335 and 336 as shown. The short to medium range wireless communication circuitry 329 may also couple to one or more antennas, such as antennas 337 and 338 as shown. Alternatively, the short to medium range wireless communication circuitry 329 may couple to the antennas 335 and 336 in addition to, or instead of, coupling to the antennas 337 and 338. The short to medium range wireless communication circuitry 329 may include multiple receive chains and/or multiple transmit chains for receiving and/or transmitting multiple spatial streams, such as in a multiple-input multiple output (MIMO) configuration.

As shown, the SOC 300 may include processor(s) 302, which may execute program instructions for the client station 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 may be configured to perform memory protection and page table translation or set up. In some embodiments, the MMU 340 may be included as a portion of the processor(s) 302.

As noted above, the client station 106 may be configured to communicate wirelessly directly with one or more neighboring client stations. The client station 106 may be configured to communicate according to a WLAN RAT for communication in a WLAN network, such as that shown in FIG. 1. Further, in some embodiments, as further described below, client station 106 may be configured to perform methods for utilizing frame buffering indications in conjunction with NAN communication.

As described herein, the client station 106 may include hardware and software components for implementing the features described herein. For example, the processor 302 of the client station 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the UE 106, in conjunction with one or more of the other components 300, 304, 306, 310, 320, 330, 335, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and also in short range wireless communication circuitry 329. Thus, each of cellular communication circuitry 330 and short range wireless communication circuitry 329 may include one or more integrated circuits (ICs) that are configured to perform the functions of cellular communication circuitry 330 and short range wireless communication circuitry 329, respectively. In addition, each integrated circuit may include circuitry (e.g., first circuitry, second circuitry, etc.) configured to perform the functions of cellular communication circuitry 330 and short range wireless communication circuitry 329.

### Wi-Fi Peer to Peer Communication Protocol

In some embodiments, Wi-Fi devices (e.g., client station 106) may be able to communicate with each other in a peer to peer manner, e.g., without the communications going through an intervening access point. There are currently two types of Wi-Fi peer to peer networking protocols in the Wi-Fi Alliance. In one type of peer to peer protocol, when two Wi-Fi devices (e.g., wireless stations) communicate with each other, one of the Wi-Fi devices essentially acts as a pseudo access point and the other acts as a client device. In a second type of Wi-Fi peer to peer protocol, referred to as a neighbor awareness networking (NAN), the two Wi-Fi client devices (wireless stations) act as similar peer devices in communicating with each other, e.g., neither one behaves as an access point.

In a NAN system, each wireless station may implement methods to ensure that it is synchronized with a neighboring wireless station to which it is communicating. Further, a wireless station may negotiate a common discovery window for exchange of synchronization packets to help ensure the stations that are communicating directly with each other are properly synchronized to enable the communication. Once two wireless stations have the same discovery window they may exchange synchronization packets to stay synchronized with each other. The wireless stations may also use the discovery window to exchange service discovery frames to convey other information such as further availability beyond discovery windows.

The NAN protocol includes two aspects: 1) synchronization and discovery (NAN 1.0) and 2) datapath transmission (NAN 2.0). NAN 1.0 describes methods for NAN protocol synchronization and discovery. After two wireless stations have discovered each other (per NAN 1.0) they may implement a procedure to setup a NAN datapath between them so that they can properly communicate. After this, the two wireless stations arrange for a common datapath negotiation window so that they can negotiate capabilities, synchronization requirements, and exchange further service information. The datapath negotiation window is a time window that enables two wireless stations to communicate with each other so that they can negotiate these capabilities and synchronization requirements and exchange this further service information. Once the datapath negotiation window has been established and NAN datapath setup has been performed, the wireless stations may perform datapath synchronization to help ensure that the two stations stay synchronized with each other for proper communication. Datapath resource allocation relates to two peer wireless stations communicating with each other regarding a common time slot and channel for communication. In other words, the two stations communicate with each other regarding which channel they should use and at which time slot, to help ensure proper communication between them. Additionally, the two stations communicate with each other regarding which channel and time slot each would prefer to use for future communications between the stations. Embodiments described herein further define methods for utilizing frame buffering indications in conjunction with NAN communication.

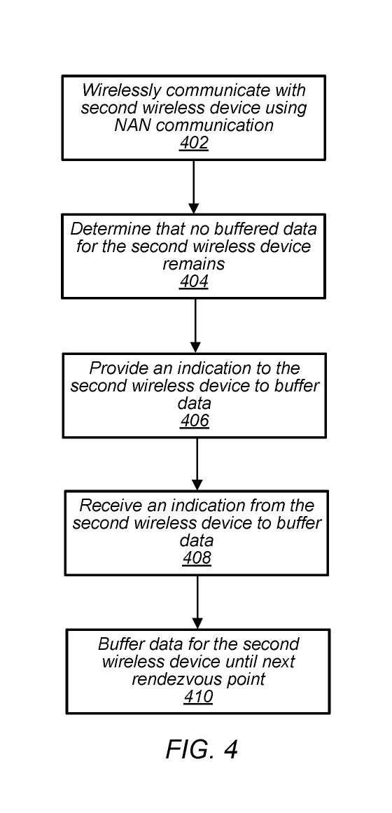

### FIG. 4—Flowchart

In NAN communication systems as well as in many other peer-to-peer wireless communication systems, there may be many different types of communication that can be performed, potentially including any or all of service discovery, ranging setup, datapath setup, synchronization signaling, scheduling, and/or data frame exchanges, among various possibilities. At least according to some embodiments, peer devices in a peer-to-peer system may accordingly provide availability windows (e.g., discovery windows, further availability windows) to allow for scheduled and unscheduled communications with other peer devices in the system.

In order to ensure that sufficient resources are available for any desired communications, it may be useful to provide a conservative amount of availability, e.g., as much or more than might be expected to be used. However, if the full extent of the availability windows offered by a wireless device are not fully used, this may also lead to unnecessary power consumption, as the wireless device may remain awake during potentially substantial periods of time while no communications are being performed.

This drawback may be at least partially mitigated if a mechanism exists for wireless devices to indicate to each other when there is no further data to be communicated in a given communication window and to agree to buffer any further data that arises until an agreed upon rendezvous point. For example, in such a case, each wireless device may be able to dynamically enter a low-power (e.g., sleep) mode even during a scheduled communication window, e.g., if it has no further communications scheduled with peer devices and has confirmed that those peer devices will buffer data for a known amount of time. Accordingly, FIG. 4 is a flowchart diagram illustrating a method for a wireless device to exchange frame buffering indications in a peer-to-peer communication system, according to some embodiments.

Aspects of the method of FIG. 4 may be implemented by a wireless device/wireless station (such as a client station 106 and/or WLAN access point 112 illustrated in and described with respect to various of the Figures herein), or more generally in conjunction with any of the computer systems or devices shown in the above Figures, among other devices, as desired. Note that while at least some elements of the method of FIG. 4 are described in a manner relating to the use of communication techniques and/or features associated with NAN and/or Wi-Fi specification documents, such description is not intended to be limiting to the disclosure, and aspects of the method of FIG. 4 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 4 may operate as follows.

A first wireless device may communicate data with a second wireless device using peer-to-peer (e.g., NAN) communication (402). According to some embodiments, the first and second wireless device may have established a neighbor data link, such as a paging neighbor data link (P-NDL) or a synchronization neighbor data link (S-NDL). The first and second wireless device may further have exchanged scheduling information such that each knows of current and/or upcoming communication windows in which both devices are planning to be active and able to communicate with each other (e.g., common resource blocks or CRBs).

In some instances (e.g., if the first and second wireless device have a P-NDL), the communication may be initiated within a CRB by way of a paging frame provided by one of the peers followed by a trigger frame provided by the other of the peers. Alternatively (e.g., if the first and second wireless device have a S-NDL), the peers may be able to exchange data immediately upon the beginning of a CRB. The data communication may include provision of one or more data packets from the first wireless device to the second wireless device, and/or provision of one or more data packets from the second wireless device to the first wireless device.

At some point, one or both peers may empty their buffers of data intended for the other peer. For example, as illustrated in FIG. 4, the first wireless device may determine that no buffered data for the second wireless device remains at the first wireless device (404), and/or vice versa.

Based at least in part on determining that there is no remaining buffered data for the peer device, one of the wireless devices may provide an indication to the other wireless device to buffer data for the wireless device. For example, as illustrated in FIG. 4, the first wireless device may provide an indication to the second wireless device to buffer data for the first wireless device (406), and/or the second wireless device may provide an indication to the first wireless device to buffer data for the second wireless device (408). The indication(s) may be acknowledged by the receiving peer(s), at least according to some embodiments.

At least in some instances, one or more additional considerations may be at least partially instrumental in causing a wireless device to provide an indication to its peer device to buffer data for the wireless device. For example, as one possibility, a wireless device may monitor how long it has been since it has received any data from its peer device, and may determine to provide the indication to the other wireless device to buffer data for the wireless device based at least in part on that length of time (e.g., if the length of time is greater than a predetermined threshold amount of time).

As another possibility, one or both of the peer devices may provide an indication to the other peer device when it has no remaining data buffered for the other peer device, and such an indication (or indications) may be used in determining if/when a wireless device provides an indication to a peer device to buffer data for the wireless device, and potentially stops transmitting to and receiving from the peer. For example, based on an indication from the second wireless device that it has no remaining data buffered for the first wireless device, once the first wireless device also completes the transmission of all buffered data for the second wireless device, it may provide an indication to the second wireless device that both devices shall not transmit and receive data to/from each other until next rendezvous point. Similarly, based on an indication from the first wireless device that it has no remaining data buffered for the second wireless device, once the second wireless device also completes the transmission of all buffered data for the first wireless device, it may provide an indication to the first wireless device that both devices shall not transmit and receive data to/from each other until next rendezvous point. The indication to signal no remaining data buffered and the indication to signal stopping transmission and receiving may be provided as part of a data frame (e.g., a data frame including the last data buffered for the peer device) or as part of a null (e.g., empty) frame, for example after the data frame including the last data buffered for the peer device has been sent, among various possibilities. As another possibility, such indications may be provided by a special control or management frame, or as part of the frame, e.g., after the last data buffered for the peer has been sent. In some instances, after a wireless device provides either an indication that signals that it has no remaining data buffered or an indication to signal stopping transmitting and receiving to a peer, it may start to buffer future data for the peer until a next rendezvous point.

Based on receiving an indication to buffer data for a peer device, a wireless device may buffer data for the peer device until a predetermined (e.g., agreed upon in advance) rendezvous point. For example, as illustrated in FIG. 4, the first wireless device may buffer data for the second wireless device until the next rendezvous point arranged by the first and second wireless devices (e.g., based on receiving the indication from the second wireless device to buffer data for the second wireless device) (410).

Alternatively or additionally, in some instances, a wireless device may buffer data for a peer device until a predetermined rendezvous point based at least in part on providing an indication to buffer data for the wireless device to the peer device. For example, it may be implied as part of such an indication that the wireless device will also buffer data for the peer device.

The predetermined rendezvous point may be determined in any of various ways, as desired. According to some embodiments, rendezvous points may be scheduled according to periodic intervals, such that multiple rendezvous points may occur within a single common resource block (e.g., if the periodic interval is shorter than the length of the common resource block), and/or rendezvous points may skip one or more common resource blocks (e.g., if the periodic interval is longer than the length between common resource blocks). Thus, as one possibility, the predetermined rendezvous point may be a rendezvous point scheduled within the same common resource block in which the data communication between the first and second wireless device already occurred. Additional or alternatively, according to some embodiments, rendezvous points may be scheduled to coincide with the beginning of each common resource block. Thus, as another possibility, the predetermined rendezvous point may be a rendezvous point coinciding with the start of the next common resource block scheduled between the first wireless device and the second wireless device.

According to some embodiments, one or both of the wireless devices may enter a low power (e.g., sleep) mode based at least in part on providing an indication to buffer data to a peer device and/or based at least in part on receiving an indication to buffer data from a peer device. For example, if either device does not have any other wireless data communication activities active or scheduled, once the peer devices have confirmed that they will buffer data for each other until the predetermined rendezvous point, that device may be able to sleep until its next scheduled communication activity (e.g., the predetermined rendezvous point, or possibly a rendezvous point with another peer device. Thus, as one possibility, the first wireless device may enter a low power mode until the predetermined rendezvous point based at least in part on providing an indication to the second wireless device to buffer data for the first wireless device and/or based at least in part on receiving an indication from the second wireless device to buffer data for the second wireless device, e.g., if no other wireless data communication activities are scheduled for the first wireless device until the predetermined rendezvous point.

Thus, at least according to some embodiments, peer device that make use of frame buffering indications such as according to the method of FIG. 4 may be able to reduce their power consumption, e.g., when resources scheduled for peer-to-peer communication turn out to be greater than needed for the actual amount of data that the peer devices have to exchange.

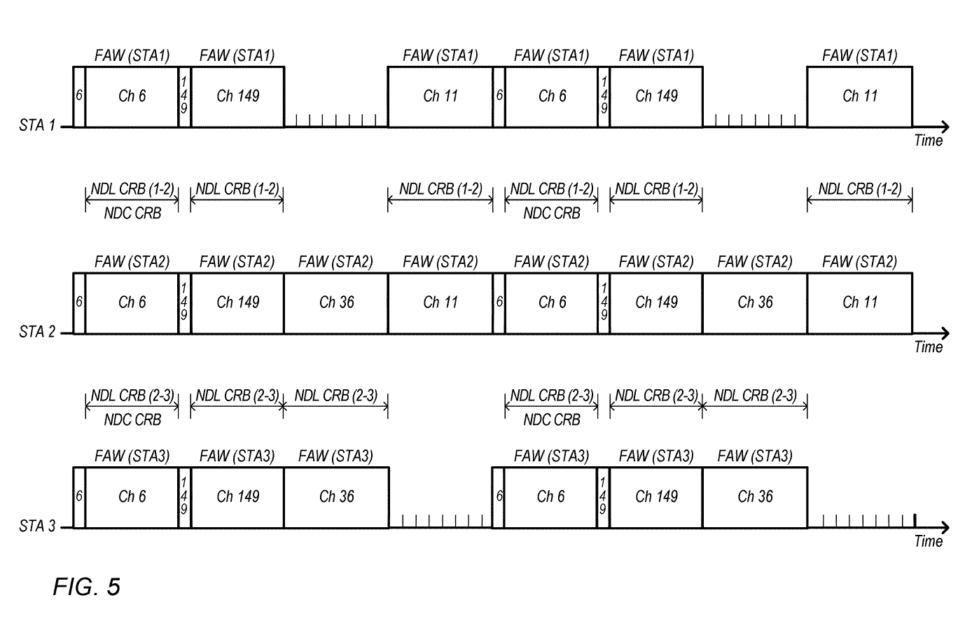

### FIGS. 5-17—NAN Frame Buffering Indications

FIGS. 5-17 and the following information are provided as being illustrative of further considerations and possible implementation details relating to the method of FIG. 4, and are not intended to be limiting to the disclosure as a whole. Numerous variations and alternatives to the details provided herein below are possible and should be considered within the scope of the disclosure.

FIG. 5 illustrates an example of a possible NAN communication schedule among several wireless stations (STA 1, STA 2, STA 3). As shown, various time windows may be indicated as further availability windows (FAWs) on certain channels by each wireless station. Overlapped portions of the FAWs between multiple stations may serve as common resource blocks (CRBs) for those wireless stations. As shown, some time blocks may function as a CRB for all wireless stations in a NAN data cluster (NDC), while some time blocks may function as a CRB between wireless station pairs.

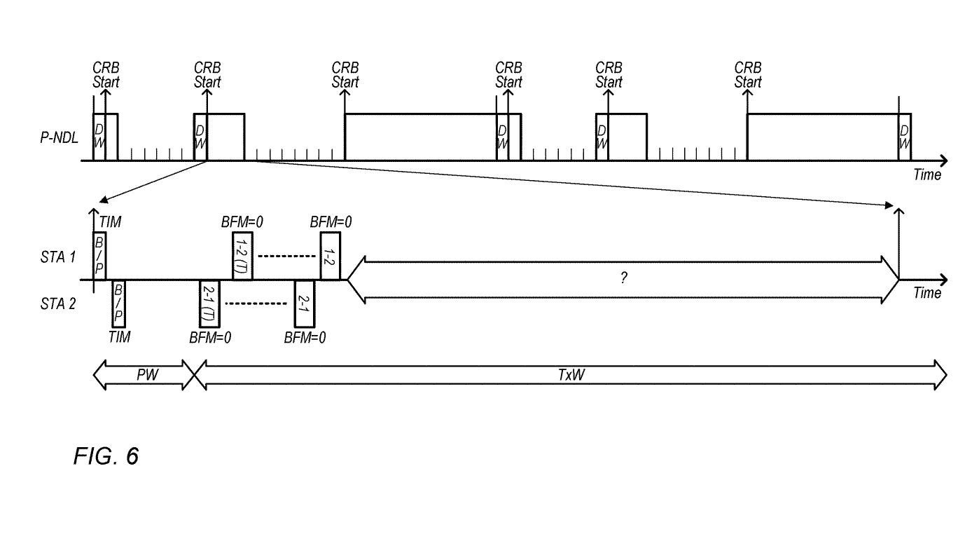

FIG. 6 illustrates an example of a possible NAN communication timeline between two wireless stations (STA 1, STA 2) that have established a paging NAN data link (P-NDL). As shown, in such a scenario, each P-NDL CRB may be divided into a paging window (PW) and a transmission window (TxW). If either station has buffered data for its peer, it may transmit a paging frame within the PW. The paging frame may include a traffic indication map (TIM), which may indicate whether the station has buffered data for one or more peer stations. When the peer receives the paging frame, it may transmit a trigger frame at the beginning of the TxW to solicit the data. If a station does not have any buffered data for the peer, nor does it receive any paging frame that indicates it has any buffered data at a peer, it may go to sleep during the TxW.

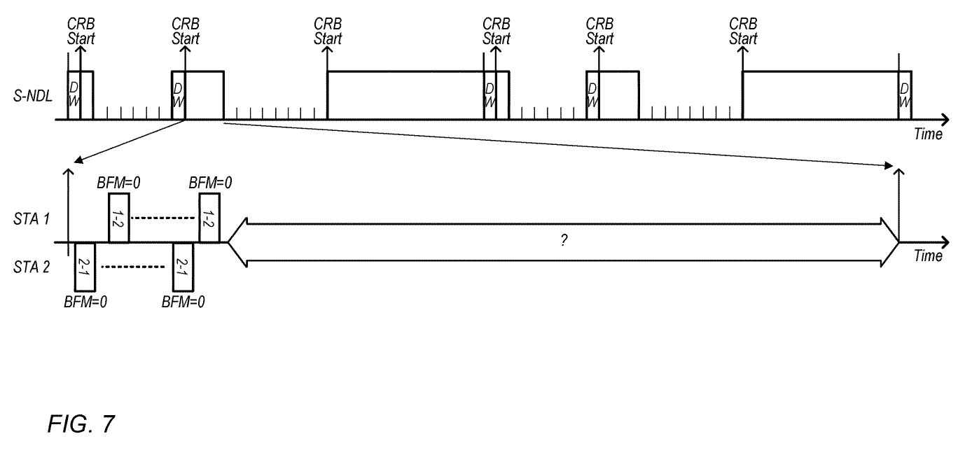

FIG. 7 illustrates an example of a possible NAN communication timeline between two wireless stations (STA 1, STA 2) that have established a synchronization NAN data link (S-NDL). As shown, in such a scenario, both stations may be awake at the beginning of each CRB, and may be able to start transmitting data to each other immediately (e.g., without paging and triggering).

As illustrated by the length of time indicated with a question mark in each of FIGS. 6-7, existing NAN communication techniques do not address the possibility that wireless stations may finish communicating in substantially less time than provided by a CRB. In other words, there may be a possibility that a wireless station could finish communicating and have no further data buffered, nor have any data for the wireless station buffered at other wireless stations, for a portion of a CRB, but would remain awake (thus unnecessarily consuming additional power compared to a sleep mode) through the remainder of the CRB nonetheless.

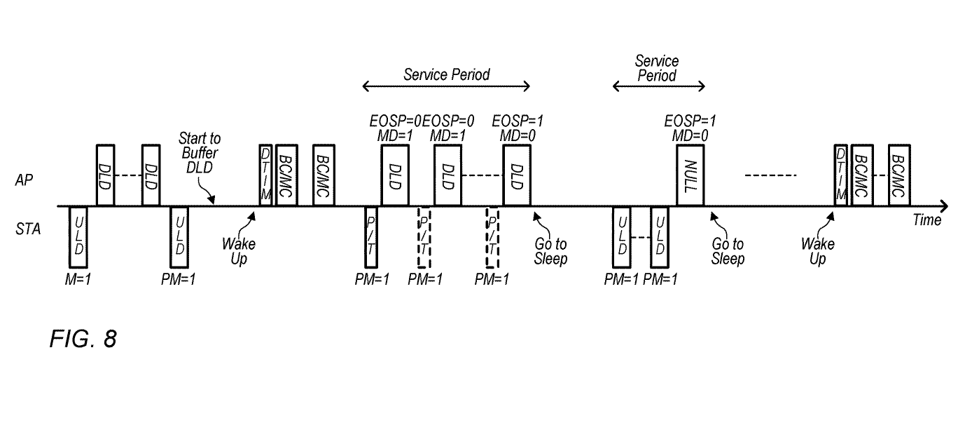

FIG. 8 illustrates an example of a possible 802.11 infrastructure mode communication timeline between an AP and a STA that includes use of data buffering indications to allow the STA to conserve power and/or for facilitating coexistence with other wireless communication technologies such as Bluetooth™. Notably, in the illustrated 802.11 infrastructure mode communication timeline and in general in 802.11 infrastructure mode communication, it may be assumed that the AP is awake at all times.

One data buffering indication may include a power management (PM) flag, which may be indicated from the STA to the AP. When the STA sets the PM flag (e.g., in order to enter sleep mode), the AP may begin buffering downlink data for the STA. The AP may release the buffered data when the STA unsets the PM flag (e.g., when the STA awakes).

Another data buffering indication may include a beacon with a TIM or DTIM. A TIM may indicate the buffered data status for associated STAs, e.g., potentially enabling STAs without buffered data to go to sleep until a subsequent beacon if the STA has no uplink data to be transmitted. Buffered broadcast and multicast data frames may be released after each DTIM beacon.

A further data buffering indication may include a PS-poll or trigger frame. Such a frame may be provided by the STA to the AP, to indicate to the AP to begin to release its buffered data for the STA. According to some embodiments, one PS-poll may be used to poll a single downlink data frame, while one trigger frame may be used to poll a sequence of downlink data frames.

The AP may be able to set a more data (MD) flag to indicate that there are still more data frames for a STA, at least in some instances. The STA may check the flag to see whether the AP has further buffered data for the STA, e.g., as part of its decision process for entering sleep mode or remaining awake.

An end of service period (EOSP) flag may be set by the AP to indicate the end of the current service period. In this case, the STA may be expected to send a new trigger frame to retrieve any further buffered frames for the STA, if there are any such frames. Thus, the STA may check the flag to see whether the AP has ended the current service period, e.g., as part of its decision process for entering sleep mode or remaining awake and potentially polling more data from the AP.

While the data buffering indications that can be used in infrastructure mode communications may be useful for helping a STA conserve power while operating in infrastructure mode, there are currently no data buffering indications defined to assist STAs performing peer-to-peer (e.g., NAN) communications with power conservation. Since in NAN communications the wireless stations may operate as full peers, there may be no assumption that one station is superior to a peer station, nor that one station will always stay awake. Accordingly, developing and utilizing a data buffering indication framework in a NAN-based communication system may reduce power consumption among wireless stations, at least according to some embodiments.

As part of such a framework, one possible data buffering indication may include a “buffer frames for me” (BFM) indication or flag. When provided from a first wireless station to a second wireless station, such a flag may indicate to the second wireless station to please buffer data for the first wireless station, after the frame with the BFM indication is successfully transmitted and acknowledged. The first wireless station may also buffer frames for the second wireless station based on providing the BFM indication.

Another possible data buffering indication may include a “no buffered frames for you” (NBF) indication or flag. When provided from a first wireless station to a second wireless station, such a flag may indicate to the second wireless station that the first wireless station does not currently have any data frames for the second wireless station buffered.

Such a framework may, at least in some instances, make use of TIMs. For example, a wireless station may indicate (e.g., during a paging window) whether it has buffered data for each of one or more peer stations using a TIM.

A further aspect of such a framework may include the use of rendezvous points (RPs). Since there may not be a station that is assumed to be awake at all times, if two stations agree to buffer frames for each other, it may be important for the stations to also agree upon a time at which the stations can release the buffered frames. Such points in time may be referred to as RPs.

Additionally, a “buffer for you” (BFY) indication or flag may also be used as part of such a framework. When provided from a first wireless station to a second

wireless station, such a flag may indicate to the second wireless station that the first wireless station will buffer data frames for the second wireless station.

According to some embodiments, once a station pair establishes a NDL, both stations may maintain an internal buffer switch (e.g., ON or OFF) for each other. When the buffer switch is OFF, a station may transmit frames to the peer during their CRBs, e.g., provided the medium access rules and NDL rules allow the transmission. When the buffer switch is ON, a station may buffer all frames for the peer.

During a CRB, if a station completes the transmission of all buffered frames, and it does not receive any transmission from the peer for a certain (e.g., relatively long) period of time (e.g., 3 ms, 5 ms, 8 ms, 10 ms, or any other desired length of time), it may transmit to the peer a unicast frame with a BFM flag set to 1. Note that the unicast frame with the BFM flag set can be the station's last buffered data frame for the peer, or it can be a null (empty) frame. Once the unicast frame with BFM flag set is acknowledged by the peer, both stations may set their respective buffer switches to ON and start to buffer all frames for each other. Both stations may reset their buffer switches to OFF for each other upon reaching the next RP.

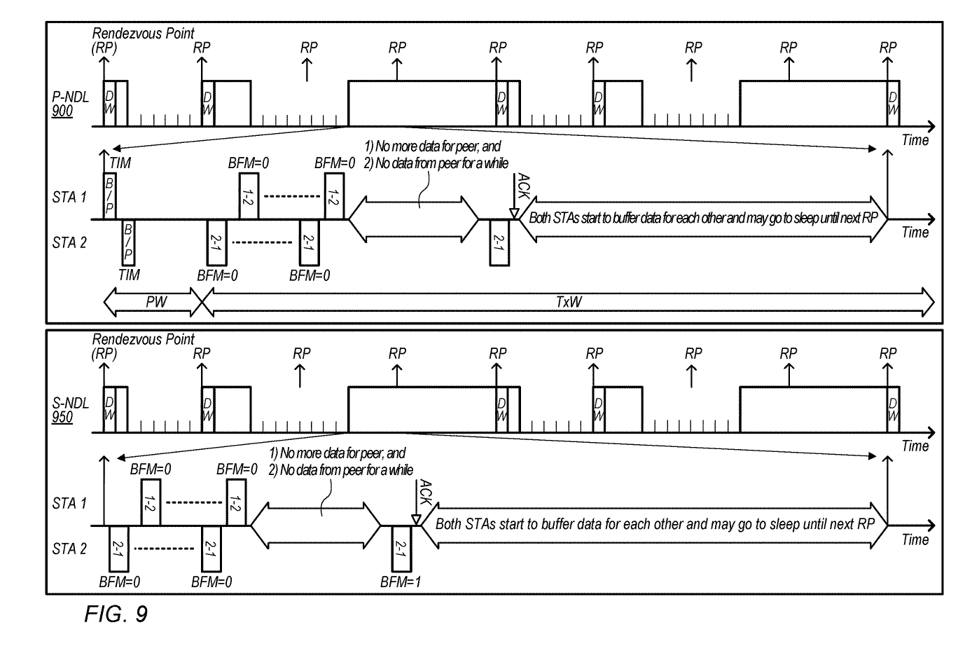

FIGS. 9-11 illustrate example scenarios in which power saving may occur using such a BFM indication, according to some embodiments.

FIG. 9 illustrates P-NDL communication 900 and S-NDL communication 950 between two STAs (STA 1, STA 2), in which both STAs have some data buffered for the other STA at the beginning of a CRB. As shown, the STAs may exchange data frames (after a paging window in the case of the P-NDL communication) with BFM=0 for a certain amount of time, eventually emptying their buffers for each other. After a predetermined period of time in which there is no further data received from the peer and no further data for the peer, one of the STAs (e.g., STA 2 as illustrated) may transmit a frame with BFM=1, which the other STA may successfully receive and acknowledge. Based on providing and receiving this indication, both STAs may start to buffer data for each other and may go to sleep (e.g., provided there are no other current activities, such as communication with another STA, in progress for the STA) until the next RP between the STAs. In some instances, one of the STAs (e.g. STA 1) that empties its buffer first may transmit a frame with a NBF=1 or BFY=1 indication, and may start to buffer future data for the peer (e.g., STA 2). In such a case, STA 2 may continue transmitting data to STA 1 until it also empties its buffer. STA 2 may then transmit a frame with BFY=1 and/or BFM=1 indication(s). After that, both STAs may stop transmitting to and receiving from each other until the next RP.

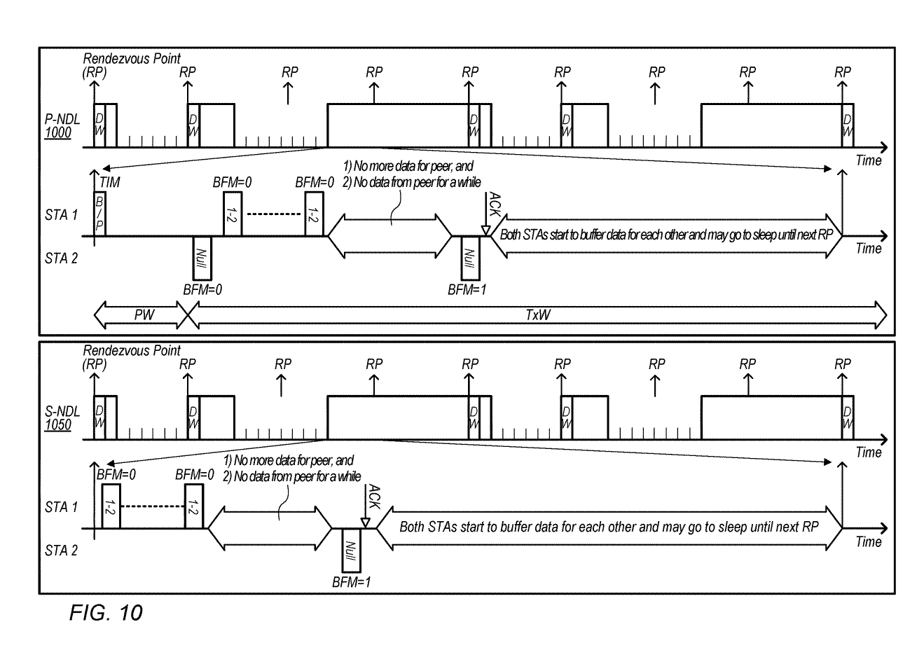

FIG. 10 illustrates P-NDL communication 1000 and S-NDL communication 1050 between two STAs (STA 1, STA 2), in which only STA 1 has data buffered for STA 2 at the beginning of a CRB. As shown, STA 1 may provide data frames (after a paging window in the case of the P-NDL communication) with BFM=0 for a certain amount of time, eventually emptying its buffer for STA 2. After a predetermined period of time in which there is no further data received from STA 1, and STA 2 still has no data for STA 1, STA 2 may transmit a (e.g., null) frame with BFM=1 and/or BFY=1, which STA 1 may successfully receive and acknowledge. Based on providing and receiving this indication, both STAs may start to buffer data for each other and may go to sleep (e.g., provided there are no other current activities, such as communication with another STA, in progress for the STA) until the next RP between the STAs. In some instances, after STA 2 transmits the indication(s), it may wait for STA 1 to also transmit a frame with BFM=1 and/or BFY=1, before both STAs start to buffer data for each other and go to sleep.

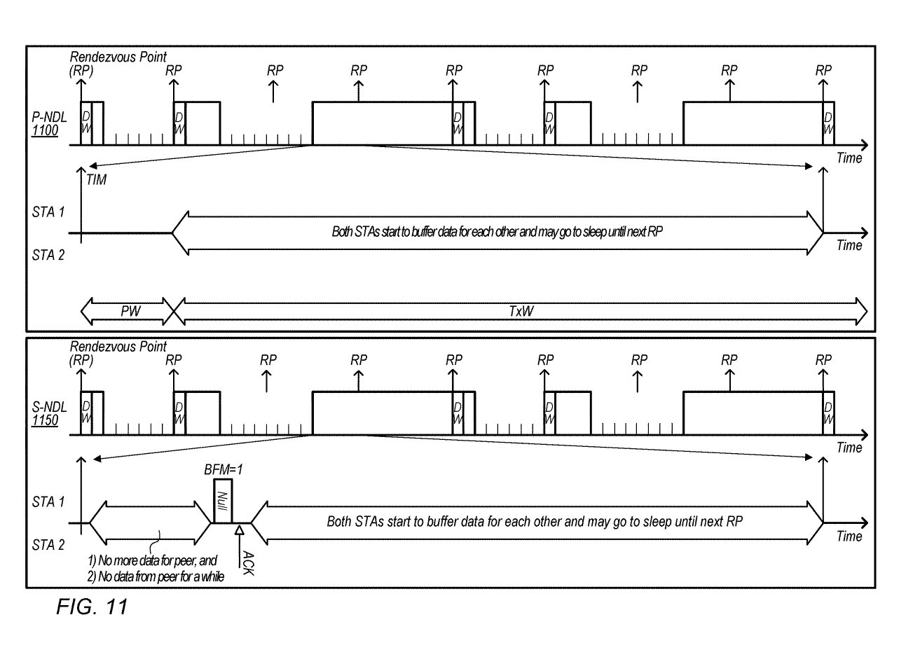

FIG. 11 illustrates P-NDL communication 1100 and S-NDL communication 1150 between two STAs (STA 1, STA 2), in which neither STA has data buffered for the other STA at the beginning of a CRB. As shown, in the case of P-NDL communication, after the paging window in which neither STA indicates any buffered frames for the other STA, both STAs may start to buffer data for each other and may go to sleep (e.g., provided there are no other current activities, such as communication with another STA, in progress for the STA) until the next RP between the STAs. In the case of S-NDL communication, after a predetermined period of time in which there is no further data received from the peer and no further data for the peer, one of the STAs (e.g., STA 1 as illustrated) may transmit a (e.g., null) frame with BFM=1 and/or BFY=1, which the other STA may successfully receive and acknowledge. Based on providing and receiving this indication, both STAs may start to buffer data for each other and may go to sleep (e.g., provided there are no other current activities, such as communication with another STA, in progress for the STA) until the next RP between the STAs. In some instances, after STA 1 transmits the indication(s), it may wait for STA 2 to also transmit a frame with BFM=1 and/or BFY=1, before both STAs start to buffer data for each other and go to sleep.

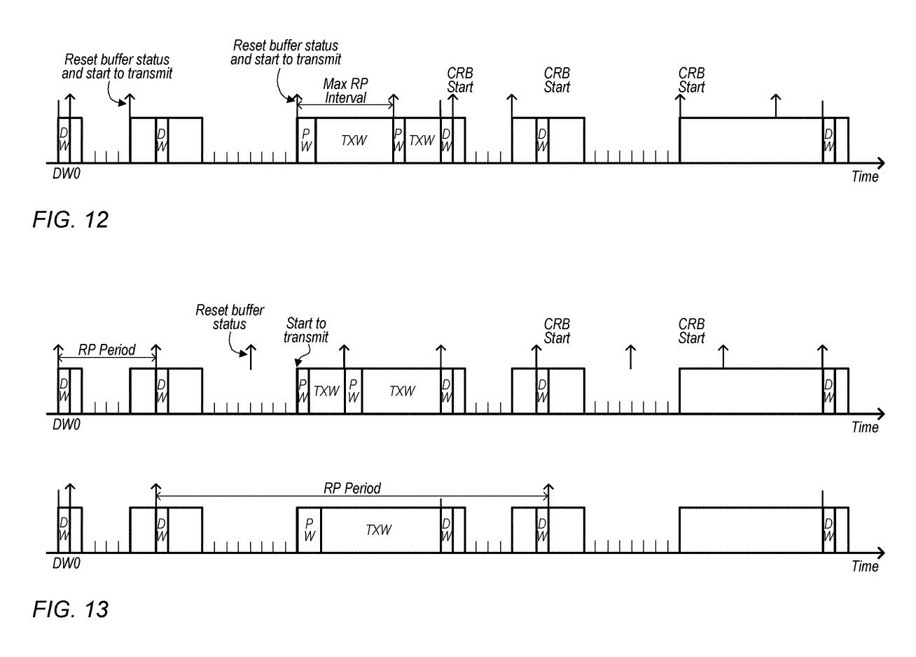

As previously noted, agreeing upon RPs may be an important aspect of a framework for utilizing frame buffering indications to conserve power. There are multiple possible approaches to selecting when RPs occur. One such possible approach is illustrated in FIG. 12. In this approach, the beginning of each CRB may be defined as being a RP. In case of long CRBs, if desired, stations establishing a NDL may also negotiate a maximum RP interval. For example, if a CRB is longer than the max RP interval, additional RPs may be added within the CRB, with the gap between two adjacent RPs equal to the max RP interval. This may effectively divide such a CRB into two or more shorter CRBs using the additional RPs (e.g., each RP may start a new CRB). Note that in the case of a P-NDL CRB, each new CRB may have its own PW and TxW.

Another such possible approach to selecting when RPs occur is illustrated in FIG. 13. In this approach, RPs are implemented as a set of periodic time points, e.g., not tied to CRBs. Stations establishing a NDL may thus negotiate a RP starting point and a RP period. According to some embodiments, the RP period may be selected from a finite set of options (e.g., 16 ms, 32ms, 64 ms, 128 ms, 256 ms, 1024 ms, 2048 ms, 4096ms, 8192 ms, as one possible set), or alternatively may be selected from any desired period length, regular or irregular. Once a station pair sets their buffer switches to ON for each other they may reset the buffer switches to OFF at the next RP. If the next RP falls within a CRB, they may begin to transmit immediately (e.g., following medium and NDL access rules). If the next RP falls outside of a CRB, they may hold the transmission until the start of the next CRB. Note that if there are one or more RPs within a CRB, the RPs may divide the CRB into multiple new/shorter CRBs, such that each RP starts a new CRB, and if the original CRB is a P-NDL CRB, each new CRB has its own PW and TxW. Such an approach may allow for longer RP periods such that the stations could skip one or more CRBs, e.g., for power saving or non-NAN operations. Furthermore, such an approach may allow for dynamic adjustment of the RP period (e.g., without changing NDL/CRB schedules), for example based on current NDL traffic conditions and/or non-NAN operation conditions.

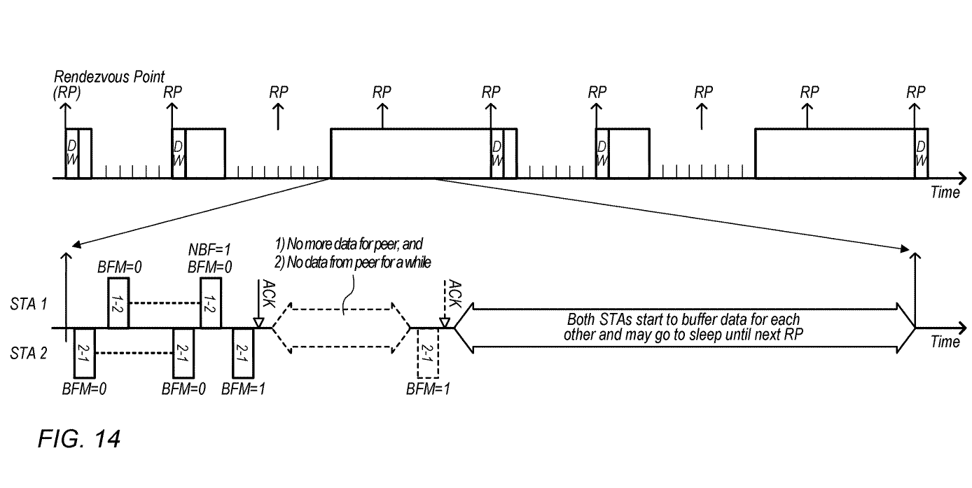

As previously noted, in some embodiments a frame buffering indication framework for NAN communication systems may include a NBF indication. FIGS. 14-16 illustrate examples of possible NAN communication between STAs in which such an indication may be used.

As shown in FIG. 14, when a station completes the transmission of all buffered data for a peer station, it may set a NBF flag in the last transmitted frame (or a null frame) to the peer. If the peer also completes (or is completing) the transmission of all buffered data for the station, the peer can set the BFM flag in the last transmitted frame (or a null frame) to the station. Once the frame with the BFM flag set is successfully acknowledged, both stations may start to buffer data for each other, and may (e.g., other activities permitting) go to sleep until the next RP. As indicated by the dashed lines in contrast with the comparable communication scenario of FIG. 9, in such a case the peer may not need to wait for a predetermined period of time without receiving data from the peer before setting the BFM flag, and both stations may thus be able to more quickly go to sleep.

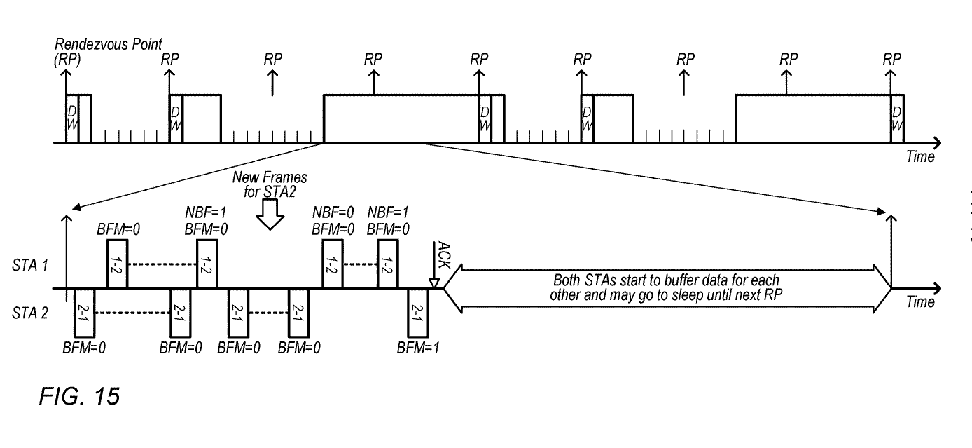

FIG. 15 also illustrates a scenario in which a station completes the transmission of all buffered data for a peer station and sets a NBF flag in the last transmitted frame (or a null frame) to the peer. In this illustrated scenario, however, the peer may still have further buffered frames for the station, and the peer may continue transmitting these frames with the BFM flag unset. During the peer's transmissions, if the station has new frames coming in for the peer, it can immediately transmit these new frames to the peer with both BFM and NBF flags unset. When both stations complete their immediate transmissions, one of the stations may send a unicast frame with BFM set, which may trigger both stations to buffer future frames for each other, and may (e.g., other activities permitting) go to sleep until the next RP. In some instances, once a station sets the NBF flag in a transmitted frame, it may start to buffer newly arrived frames for

the peer until the next RP, e.g., regardless of whether and how long the peer continues transmitting frames with the BFM flag unset.

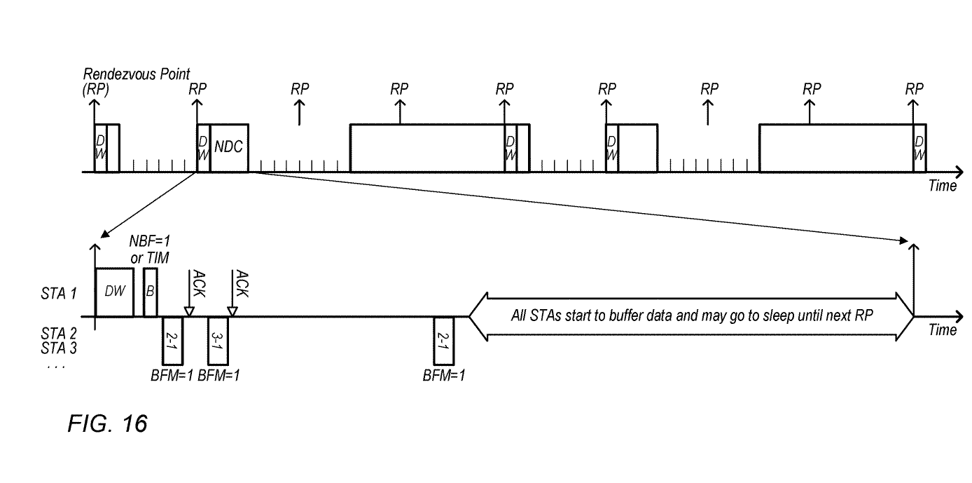

FIG. 16 illustrates a scenario in which a station has multiple peers, and in which the station does not have any buffered data for any peer at the beginning of a CRB shared with all peers (e.g., a NDC CRB). In such a scenario, the station may broadcast a frame with a NBF flag set (e.g., transmit a beacon with a NBF indication). If its peers do not have buffered data for the station either, the peers may transmit a frame with BFM set to the station, so that all stations start to buffer future data and may (e.g., other activities permitting) go to sleep until the next RP. Alternatively or in addition, if a station enables TIM support for peers, it may broadcast a frame with a TIM at the beginning of a CRB shared with all peers (e.g., a NDC CRB). Those peers that have buffered data neither from nor to the station may transmit a frame with a BFM flag set to the station.

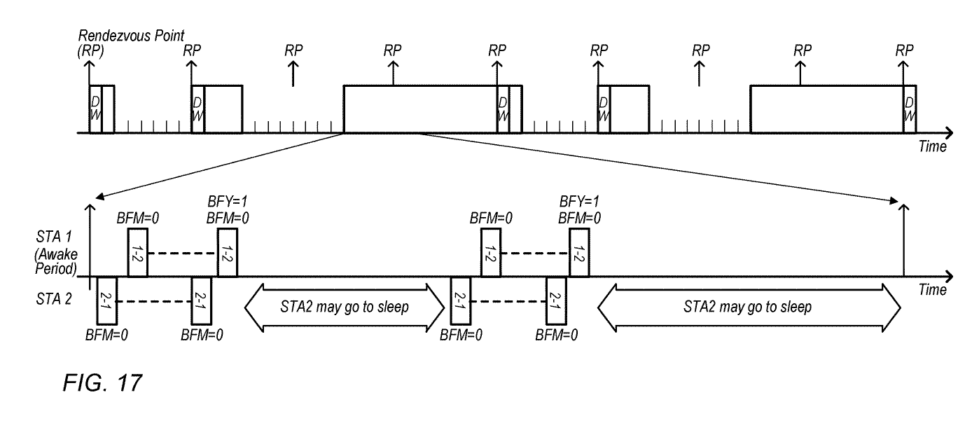

While, as previously noted, it may be the case that in NAN communication it is not assumed that any given station will be awake at all times, it may in some circumstances be the case that a station can claim that it will be awake for a certain period of time (e.g., a whole FAW, a whole CRB, until a next RP, etc.), regardless of whether the station and its peers have any frames to transmit. FIG. 17 illustrates a NAN communication scenario between two STAs (STA 1, STA 2) in which one of the STAs (STA 1) is in such an “awake period”. In such circumstances, the peers of the station may be able to transmit frames to the station at any time during the station's awake period. According to some embodiments, the station may not set a BFM flag in any frame transmitted in its awake period. During its awake period, the station may be able to set a BFY flag in a frame transmitted to a peer, and may accordingly start to buffer future frames for the peer. When the peer receives the frame with BFY set, it may be able to go to sleep immediately (e.g., other activities permitting). At any time during the awake period, the peer may be able to transmit a trigger frame to request that the station cancel buffering for the peer. The station may also or alternatively be able to broadcast a frame (e.g., a beacon) with a TIM or BFY flag. For example, the TIM bit 0 may indicate that the station will buffer frames for the corresponding peer, so that the peer may go to sleep, and the BFY flag may indicate that the station will buffer frames for all peers, until receiving a trigger from a given peer (or until a next RP). The peer may also be able to provide a BFM indication to the station during the awake period, in which case both stations may start to buffer frames for each other. However, the peer may still be able to transmit a trigger frame to cancel buffering at both sides at any time during the awake period (e.g., instead of waiting until the next RP), if desired.

In the following further exemplary embodiments are provided.

One set of embodiments may include a wireless station, comprising: at least one antenna; at least one wireless interface communicatively coupled to the at least one antenna; and at least one processor communicatively coupled to the at least one wireless interface; wherein the wireless station is configured to: wirelessly communicate data with a second wireless station using neighbor awareness network (NAN) communication techniques; receive an indication from the second wireless station to buffer data for the second wireless station; buffer data for the second wireless station until a predetermined rendezvous point based at least in part on the indication to buffer data for the second wireless station.

According to some embodiments, the wireless station is further configured to: enter a low power mode until the predetermined rendezvous point if no other wireless data communication activities are scheduled based at least in part on receiving the indication from the second wireless station to buffer data for the second wireless station.

According to some embodiments, the wireless station is further configured to: provide an indication to the second wireless station that the wireless station has no further data buffered for the second wireless station, wherein the indication from the second wireless station to buffer data for the second wireless station is based at least in part on the indication that the wireless station has no further data buffered for the second wireless station.

Another set of embodiments may include a method, comprising: by a first wireless station: wirelessly communicating data with a second wireless station using neighbor awareness network (NAN) communication techniques; providing an indication to the second wireless station to buffer data for the first wireless station; and buffering data for the second wireless station until a predetermined rendezvous point based at least in part on providing the indication to the second wireless station to buffer data for the first wireless station.

According to some embodiments, the method further comprises: entering a low power mode until the predetermined rendezvous point based at least in part on providing the indication from the second wireless station to buffer data for the second wireless station.

According to some embodiments, the method further comprises: determining that the first wireless station has no buffered data for the second wireless station, wherein the indication to buffer data for the first wireless station is provided based at least in part on determining that the first wireless station has no buffered data for the second wireless station.

According to some embodiments, the method further comprises: determining that the first wireless station has not received any data from the second wireless station for at least a predetermined amount of time, wherein the indication to buffer data for the first wireless station is provided based at least in part on determining that the first wireless station has not received any data from the second wireless station for at least a predetermined amount of time.

According to some embodiments, the method further comprises: receiving an indication from the second wireless station that the second wireless station has no further data buffered for the first wireless station, wherein the indication to the second wireless station to buffer data for the first wireless station is based at least in part on the indication that the second wireless station has no further data buffered for the first wireless station.

According to some embodiments, rendezvous points occur at predetermined periodic intervals.

According to some embodiments, rendezvous points coincide with common resource block beginnings.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a wireless device (or wireless station) may be configured to include a processor (or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus, comprising:
a processing element configured to cause a wireless device to:
wirelessly communicate data with a second wireless device using neighbor awareness network (NAN) communication techniques;
determine that the wireless device has no remaining buffered data for the second wireless device;
provide an indication to the second wireless device to buffer data for the wireless device based at least in part on determining that the wireless device has no remaining buffered data for the second wireless device; and
buffer data for the second wireless device until a predetermined time based at least in part on providing the indication to the second wireless device to buffer data for the wireless device.

2. The apparatus of claim 1, wherein the processing element is further configured to cause the wireless device to:
receive an indication from the second wireless device that the second wireless device has no remaining buffered data for the wireless device,
wherein the indication to the second wireless device to buffer data for the wireless device is provided further based on receiving the indication from the second wireless device that the second wireless device has no remaining buffered data for the wireless device.

3. The apparatus of claim 1, wherein the processing element is further configured to cause the wireless device to:
enter a low power mode based at least in part on providing the indication to the second wireless device to buffer data for the wireless device.

4. The apparatus of claim 3, wherein the processing element is further configured to cause the wireless device to:
determine that the wireless device is currently not in an active communication window with any other wireless devices,
wherein entering the low power mode is further based on determining that the wireless device is currently not in an active communication window with any other wireless devices.

5. The apparatus of claim 1,
wherein the data is wirelessly communicated with the second wireless device according to one of:
a paging neighbor data link (P-NDL); or
a synchronization neighbor data link (S-NDL).

6. The apparatus of claim 1,
wherein the predetermined time comprises one of:
a rendezvous point scheduled according to a periodic interval within a same common resource block in which the data is wirelessly communicated with the second wireless station; or
a rendezvous point coinciding with a start of a next common resource block scheduled between the wireless station and the second wireless station.

7. A wireless station, comprising:
at least one antenna;
at least one wireless interface communicatively coupled to the at least one antenna; and
at least one processor communicatively coupled to the at least one wireless interface;
wherein the wireless station is configured to:
wirelessly communicate data with a second wireless station using neighbor awareness network (NAN) communication techniques;
receive an indication from the second wireless station to buffer data for the second wireless station;
buffer data for the second wireless station until a predetermined time based at least in part on the indication to buffer data for the second wireless station;

8. The wireless station of claim 7, wherein the wireless station is further configured to:
enter a low power mode until the predetermined time if no other wireless data communication activities are scheduled based at least in part on receiving the indication from the second wireless station to buffer data for the second wireless station.

9. The wireless station of claim 7, wherein the wireless station is further configured to:
provide an indication to the second wireless station that the wireless station has no further data buffered for the second wireless station,
wherein the indication from the second wireless station to buffer data for the second wireless station is based at least in part on the indication that the wireless station has no further data buffered for the second wireless station.

10. The wireless station of claim 7,
wherein the indication to buffer data for the second wireless station is included in a data frame received from the second wireless station.

11. The wireless station of claim 7,
wherein the indication to buffer data for the second wireless station is included in a null frame received from the second wireless station.

12. The wireless station of claim 7, wherein the data is wirelessly communicated with the second wireless station during a common resource block (CRB) of one of:
a paging neighbor data link (P-NDL); or
a synchronization neighbor data link (S-NDL).

13. The wireless station of claim 7,
wherein the predetermined time comprises one of:
a rendezvous point scheduled according to a predetermined periodic interval within a same common resource block in which the wireless station wirelessly communicates data with the second wireless station; or
a rendezvous point coinciding with a start of a next common resource block scheduled between the wireless station and the second wireless station.

14. A method, comprising:
by a first wireless station:
wirelessly communicating data with a second wireless station using neighbor awareness network (NAN) communication techniques;
providing an indication to the second wireless station to buffer data for the first wireless station; and
buffering data for the second wireless station until a predetermined time based at least in part on providing the indication to the second wireless station to buffer data for the first wireless station.

15. The method of claim 14, further comprising:
entering a low power mode until the predetermined time based at least in part on providing the indication from the second wireless station to buffer data for the second wireless station.

16. The method of claim 14, further comprising:
determining that the first wireless station has no buffered data for the second wireless station,
wherein the indication to buffer data for the first wireless station is provided based at least in part on determining that the first wireless station has no buffered data for the second wireless station.

17. The method of claim 14, further comprising:
determining that the first wireless station has not received any data from the second wireless station for at least a predetermined amount of time,
wherein the indication to buffer data for the first wireless station is provided based at least in part on determining that the first wireless station has not received any data from the second wireless station for at least the predetermined amount of time.

18. The method of claim 14, further comprising:
receiving an indication from the second wireless station that the second wireless station has no further data buffered for the first wireless station,
wherein the indication to the second wireless station to buffer data for the first wireless station is based at least in part on the indication that the second wireless station has no further data buffered for the first wireless station.

19. The method of claim 14,
wherein the predetermined time comprises a next scheduled rendezvous point, wherein rendezvous points occur at predetermined periodic intervals.

20. The method of claim 14,
wherein the predetermined time comprises a rendezvous point that coincides with a beginning of a common resource block.
